(19) United States
(12) Patent Application Publication
(10) Pub. No.: US 2017/0114973 A1
(43) Pub. Date: Apr. 27, 2017

(54) SOLAR POLYMER LIGHT BAR

(71) Applicant: Loren D. Krumweide, El Cajon, CA (US)

(72) Inventor: Loren D. Krumweide, El Cajon, CA (US)

(21) Appl. No.: 15/294,568

(22) Filed: Oct. 14, 2016

Related U.S. Application Data
(60) Provisional application No. 62/246,523, filed on Oct. 26, 2015.

(51) Int. Cl. F21S 19/00; F21S 8/04; F21V 23/02; F21S 9/02; F21S 9/03; F21S 11/00; G02B 19/00

(52) U.S. Cl. CPC F21S 19/005; F21S 11/002; F21S 11/007; F21S 8/043; G02B 19/0042; G02B 19/0004; F21S 9/02; F21S 9/032; F21V 23/02; F21Y 2115/10

(57) ABSTRACT

The present invention is to direct sunlight through the Solar Polymer Light Bar using an exposed solid polymer bar or equivalent through a roof pipe flange down into a flush mounted ceiling light canister and a wide variety of mounting fixtures, including one or more interconnected light canisters, whereby the Solar Polymer Light Bar may be bent as required to avoid roof structural elements and ceiling structural elements when being installed. Optional light gathering and light emitting enhancement means can be added at the upper portion and lower portion of the solid polymer light bar, respectively. Solar powered, battery powered or house AC or DC transformer powered LEDs, CFLs or conventional incandescent light bulbs may be added to increase the light intensity emitted through the night time and dark hours if desired.

### FIELD OF THE INVENTION

This application provides a means to conduct sunlight through one or more exposed polymer bars down to a variety of different lighting fixtures with the optional addition of attached LEDs, CFLs or conventional incandescent light bulbs.

### BACKGROUND OF THE INVENTION

There exists a growing need for the saving of electrical power in homes and business structures. Solar panels have created a great awareness of the capability of using the sun's radiant energy as a power source that can be converted into electrical energy. The creation of the Solar Tubes using the sun's rays as a means of lighting has been very successful but it has some limitations. They deal with primarily ten to twelve-inch diameter fixtures that in many cases deliver too much light for accent lighting, which usually use several small lights in a row. The large hole has to be cut in the roof and the large ducting down can sometimes be a problem. Additionally, hallways generally do not need a great deal of light in one area but might require several small lights down the middle. Multiple small accent lighting has become very desirable in many of the new modern homes. Fiber optic cables deliver light effectively but are very expensive and the individual lines are very small. All of this makes a solid diameter polymer bar of 1½ inches in diameter used for the Solar Polymer Light Bar very easy to work with and less expensive.

Numerous innovations for lighting fixtures have been provided in the prior art that are described as follows. Even though these innovations may be suitable for the specific individual purposes to which they address, they differ from the present design as hereinafter contrasted. The following is a summary of those prior art patents most relevant to this application at hand, as well as a description outlining the difference between the features of the Solar Polymer Light Bar and the prior art.

U.S. Pat. No. 9,157,591 of Nathalie Rozot et al. describes a compact, autonomous, solar-powered, modular and aesthetic light fixture that produces useful light levels for general illumination, and includes a housing, photovoltaic cells configured to receive sunlight proximate an upper portion of the housing, concentrating optics at least partially covering the photovoltaic cells, a light source configured to emit light from the housing, an energy storage device to receive energy from the photovoltaic cells and to provide energy to the light source, an electronic energy management system for controlling charge associated with the photovoltaic cells, the energy storage device and the light source. The light fixture can be rotated 360 degrees to accommodate any solar irradiation while sustaining a consistent appearance, it can accommodate a variety of mounting conditions, and it can be combined to form lighting systems in a variety of configurations.

This patent describes a compact, autonomous, solar-powered, modular and aesthetic light fixture with photovoltaic cells to provide energy to the light source, an electronic energy management system for controlling charge associated with the photovoltaic cells, the energy storage device and the light source. This complicated system does not provide the compact, inexpensive, easy to install capabilities of the Solar Polymer Light Bar system.

U.S. Pat. No. 8,931,914 of Ji Yong Kim describes a flexible solar light includes a lamp portion, a main body portion, and a goose neck portion. The goose neck portion connects the lamp portion and the main body portion, which is flexible and configured to be bent in a shape and maintains the bent shape. The lamp portion and the main body portion are configured to form a portable flashlight, a light stand, a wall lamp, or a ceiling lamp by engaging or separating each other.

This patent describes a lamp portion and the main body portion that are configured to form a portable flashlight, a light stand, a wall lamp, or a ceiling lamp but does not have the unique features of the Solar Polymer Light Bar system.

U.S. Pat. No. 8,545,078 of Byung Chul Kim describes a solar lighting apparatus that uses optical fibers to transmit solar light for illumination. The apparatus includes a support frame, optical fibers, a hybrid solar light diffuser and a reflective sheet. The optical fibers are fastened to the support frame and are spaced apart from each other at regular intervals. The hybrid solar light diffuser is coupled to a lower portion of the support frame and includes a diffusion plate and diffusion lenses which are provided on the diffusion plate at positions corresponding to the respective optical fibers. Each diffusion lens has a width increasing from a top thereof to a bottom. An incident depression is formed in the upper end of each diffusion lens. A reflective surface is formed on the circumferential outer surface of each diffusion lens to diffuse and reflect solar light. The reflective sheet is applied to the lower surface of the support frame.

This patent describes a solar lighting apparatus that uses optical fibers to transmit solar light for illumination. This system uses fiber optic fibers that are very fine and expensive to create a complicated lighting application and does not provide the compact, inexpensive, easy to install capabilities of the Solar Polymer Light Bar system.

US Patent Application Publication No. 2011/0141570 of David Windsor Rillie et al. states that some embodiments provide a daylighting apparatus comprising an internally reflective tube configured to direct daylight from a first end of the tube to second end of the tube opposite the first end. A diffuser can be positioned at the second end of the tube. The diffuser can comprise a first optical structure configured such that, when the daylighting apparatus is installed with the first end positioned outside a room and the second end positioned to provide light to the room, a reflected portion of the daylight is directed towards at least one upper region (e.g., a ceiling or upper wall surface) of the room and a transmitted portion of the daylight is directed towards at least one lower region (e.g., a floor surface) of the room.

This patent describes a type of Solar tube but does not use a small diameter bar to convey light down as described by the Solar Polymer Light Bar application.

The foregoing prior art does not provide the benefits attendant with the Solar Polymer Light Bar. The present design achieves its intended purposes, objects and advantages over the prior art devices through a new, useful and unobvious combination of method steps and component elements, with the use of a minimum number of functioning parts, at a reasonable cost to manufacture, and by employing readily available materials.

### SUMMARY OF THE INVENTION

The principle advantage of the Solar Polymer Light Bar is to supply interior access or accent lighting in a structure or home.

Another advantage of the Solar Polymer Light Bar is that no electricity is required.

Another advantage of the Solar Polymer Light Bar is the ease of installation.

Another advantage is with the configuration of the Solar Polymer Light Bar the installation openings do not have to he in a direct vertical alignment.

Another advantage of the Solar Polymer Light Bar is additional light can be added by incorporating solar powered or house powered LEDs, CFLs or conventional incandescent light bulbs.

Another advantage of the Solar Polymer Light Bar is the LEDs can be wired through a transformer to house current and set up with a wall switch.

Another advantage of the Solar Polymer Light Bar is that a variety of upper light accumulators and lower light dispersers can change the lighting intensity and effects.

Another advantage of the Solar Polymer Light Bar is it can have a variety of light mounting ceiling canisters and light fixtures.

Another advantage of the Solar Polymer Light Bar is it can consist of a solid acrylic bar, multiple smaller acrylic bars, glass, or a sealed tubular member filled with a variety of semi-transparent liquids.

Another advantage of the Solar Polymer Light Bar is it can be bent at a right angle and still effectively transmit light

Another advantage of the Solar Polymer Light Bar is that it is smaller than the conventional solar tubes and can be used in multiple locations for accent lighting or down a dark hallway.

The Solar Polymer Light Bar assembly consists of a polymer bar or other suitable material that is heated and bent, or may be casted, in an offset configuration to allow for articulation around construction member obstacles such as rafters, ceiling joists, attic and roof mounted equipment. This allows for the desired positioning of the lighting fixture. The polymer bar of 1½-inch diameter is the preferred size with a variety of different sizes available and should be considered as being within the scope of this application. A sealed polymer tube filled with a variety of semi-transparent liquids to convey light equally as well as the polymer bar can be used in the Solar Polymer Light Bar system. The top of the polymer bar can be flat but it has been found that by increasing the surface area by using a conical shape, a domed spherical shape or a tiered accumulator shape, a brighter light is achieved. The length of the polymer bar does not significantly diminish the light.

The polymer bar mounts to a conventional flush mount ceiling light canister with a bar clamping nut and can extend to different positions. An optional iris type of closure mechanism, or a concave flappable cover, has been designed to close off the light when it is desired. The lower end of the polymer bar can be smooth on the bottom and smooth on the sides or it can have a decorative ornamental design to spread light against the reflective silvered insert of the light canister. A lower light disperser has been designed to further spread the light at the lower end of the polymer bar. The tiered accumulator at the top of the polymer bar and the lower light disperser at the bottom have angled tiers in the opposite direction to effectively collect or disperse the light. Glass light fixtures can mount to the ceiling light canister. Alternatively, the Solar Polymer Light Bar can enter through a light fixture from the backside, or stick bare through the ceiling directly in a raw type configuration.

An LED light system powered by a solar panel and batteries or house power is available to extend the lighting capabilities into the night. One or more small holes or slots are drilled at an angle (lights faced toward fixture end) downward in the area of the ceiling light canister where the LEDs are inserted.

Additionally a cluster of small diameter rods can be used to be fanned out for a decorative lighting arrangement. A variety of solar reflectors and magnifiers can increase the light entering the top of the polymer bar. The polymer bar can be installed in a wall and bent at right angles for lighting a wall sconce.

With respect to the above description then, it is to be realized that the optimum dimensional relationships for the parts of this application, to include variations in size, materials, shape, form, function and manner of operation, assembly and use, are deemed readily apparent and obvious to one skilled in the art. All equivalent relationships to those illustrated in the drawings and described in the specification intend to be encompassed by the present disclosure. Therefore, the foregoing is considered as illustrative only of the principles of the Solar Polymer Light Bar. Further, since numerous modifications and changes will readily occur to those skilled in the art, it is not desired to limit the design to the exact construction and operation shown and described, and accordingly, all suitable modifications and equivalents may be resorted to, falling within the scope of this application.

### BRIEF DESCRIPTION OF THE DRAWINGS

The accompanying drawings, which are incorporated in and form a part of this specification, illustrate embodiments of the Solar Polymer Light Bar and together with the description, serve to explain the principles of this application.

FIG. 1 depicts a side view of the Solar Polymer Light Bar installation through a roof and down into a ceiling light canister.

FIG. 2 depicts a cross section through a coupling between two sections of the polymer bar.

FIG. 3 depicts a cutaway side view of a conventional light ceiling canister with an iris closure and the polymer bar having a textured surface.

FIG. 4 depicts a bottom view of the iris closure on the ceiling canister.

FIG. 5 depicts a cutaway side view of a conventional light ceiling canister with a dome shaped light fixture, wherein the dome may be an operable dome which slides over to direct light in a certain direction or act as a shade to reduce the light emitted from the fixture.

FIG. 6 depicts a side view of the polymer bar installation through a roof and down into a ceiling light canister that has been cutaway illustrating the incorporation of LEDs and a solar panel on the roof.

FIG. 7 depicts the use of the Solar Polymer Light Bar to aluminate an exit sign.

FIG. 8 depicts the top of the polymer bar with an optional upper light accumulator.

FIG. 9 depicts as section of a sealed polymer tube filled with a variety of semi-transparent liquids.

FIG. 10 depicts a cutaway side view of a ceiling light canister with a dome shaped light fixture and an optional lower light disperser on the polymer bar that can change the lighting intensity and effects.

FIG. 11 depicts a cutaway side view of a ceiling light canister with a quantity of small polymer rods in a cluster forming a decorative display.

FIG. 12 depicts a cutaway side view of a ceiling light canister with the polymer bar extending further down into a larger light fixture.

FIG. 13 depicts a polymer bar in a wall and bent at right angles for use as a wall sconce.

FIG. 14 depicts a cross section of an optional solar reflector used to increase the light entering the polymer bar end.

FIG. 15 depicts an exploded perspective view of a through the roof ceiling mounting fixture.

FIG. 16 depicts an exploded perspective view of an internal ceiling mounting fixture.

FIG. 17 depicts an exploded perspective view of an internal ceiling mounting fixture using a conventional glass dome.

FIG. 18 depicts an exploded perspective view shed lighting fixture.

FIG. 19 depicts an exploded perspective view of a patio lighting fixture.

For a fuller understanding of the nature and advantages of the Solar Polymer Light Bar, reference should he had to the following detailed description, taken in conjunction with the accompanying drawings which are incorporated in and form a part of this specification, illustrate embodiments of the design and together with the description, serve to explain the principles of this application.

### DETAILED DESCRIPTION OF THE PREFERRED EMBODIMENTS

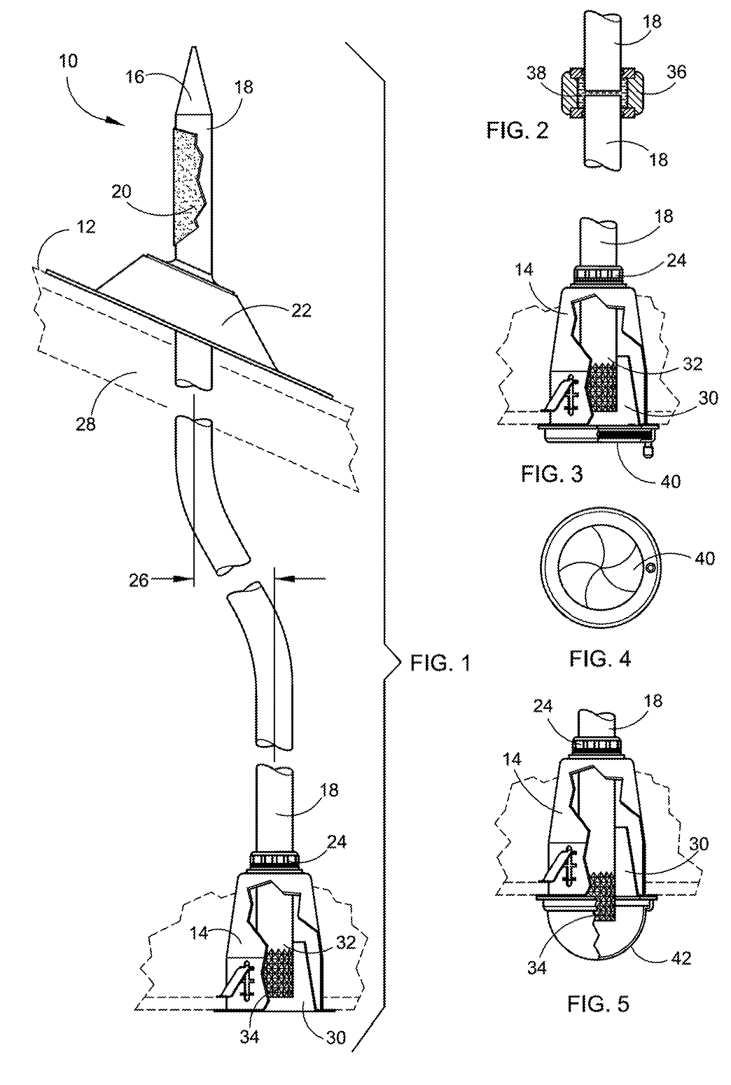

Referring now to the drawings, wherein similar parts of the Solar Polymer Light Bar 10 are identified by like reference numerals, there is seen in FIG. 1 a side view of the Solar Polymer Light Bar 10 installation through a roof 12 and down into a conventional flush ceiling light canister 14. The top conical section 16 of the polymer bar 18 can have other shapes to effectively increase the surface area for sunlight absorption. The polymer bar 18 can be left clear or have silvered reflective coating 20. The polymer bar 18 will extend through a conventional roof pipe flange 22 down to the bar clamping nut 24 of the ceiling light canister 14. The polymer bar 18 is bent in an offset configuration 26 to allow for location adjustments and articulation around construction members 28. The offset configuration 26 can be preordered to vary from two to twelve inches. A light reflective silvered insert 30 is a conventional part of light canisters 14. The lower end 32 of the polymer bar 18 has been shown with a decorative ornamental design 34 on the side surface or can be left smooth. The polymer used to construct the polymer bar may be UV resistant polymer materials commonly found and readily obtained.

FIG. 2 depicts a cross section through a coupling 36 between two sections of the polymer bar 18 that can be filled with a transparent material or liquid 38 to help transmit the light through the connection.

FIG. 3 depicts a cutaway side view of a ceiling light canister 14 with an iris type of closure mechanism 40 and the polymer bar 18 having a decorative ornamental design 34 on the site surface.

FIG. 4 depicts a bottom view of the iris type of closure mechanism 40 on the ceiling light canister 14.

FIG. 5 depicts a cutaway side view of a ceiling light canister 14 with the polymer bar 18 having battery powered LEDs, not exposed to the sunlight but extends down into a dome style of light fixture 42 for accent lighting. The dome may be an operable moveable dome which may be slid over to direct light in a certain direction, or the operable dome may act as a shade, to reduce the light emitted from the fixture.

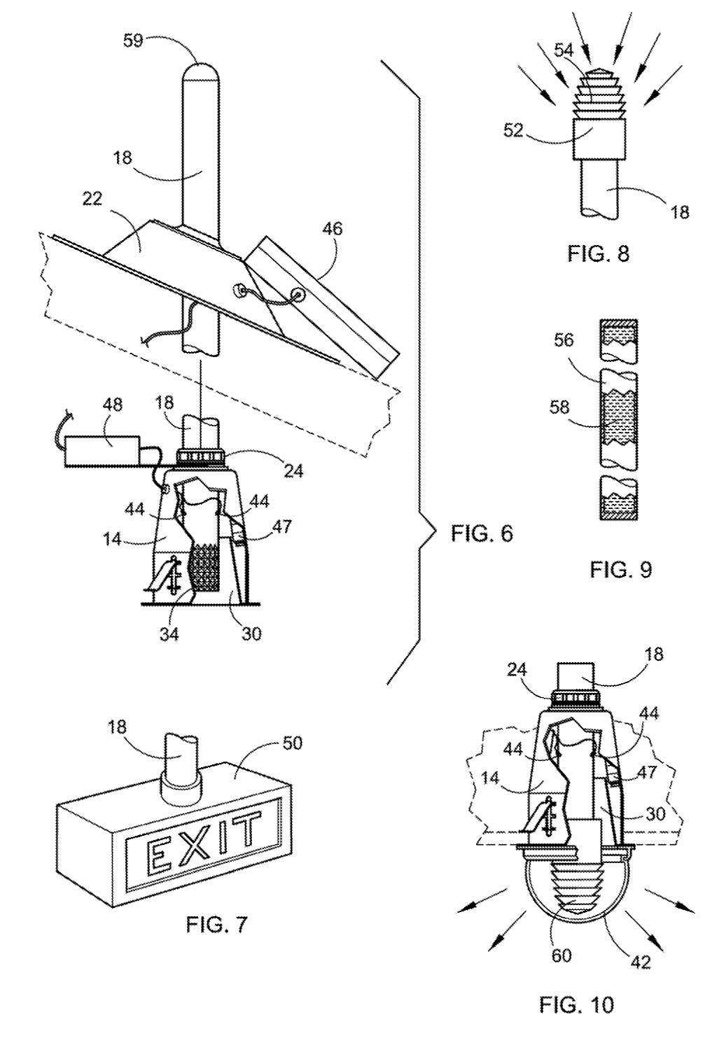

FIG. 6 depicts a side view of the Solar Polymer Light Bar 10 installation through a roof 12 and down into a ceiling light canister 14 that has been cutaway illustrating the incorporation of LEDs 44. A solar panel 46 on the roof 12 will produce electricity to charge one or more battery 47 or house power in the form of AC or DC) can be connected to a transformer 48 to light the LEDs 44. An optional domed cap 59 is formed on the top of the polymer bar 18.

FIG. 7 depicts the use of the Solar Polymer Light Bar 10 to illuminate an exit sign 50.

FIG. 8 depicts the top of the polymer bar 18 with an optional upper light accumulator 52 that has been designed to increase the surface area 54 to the light striking the end of the polymer bar 18.

FIG. 9 depicts a section of a sealed polymer tube 56 filled with a variety of semi-transparent liquids 58 to convey light equally as well as the polymer bar 18 to be used in the Solar Polymer Light Bar 10.

FIG. 10 depicts a cutaway side view of a ceiling light canister 14 with a dome shaped light fixture 42 and an optional lower light disperser 60 that can change the lighting intensity and effects.

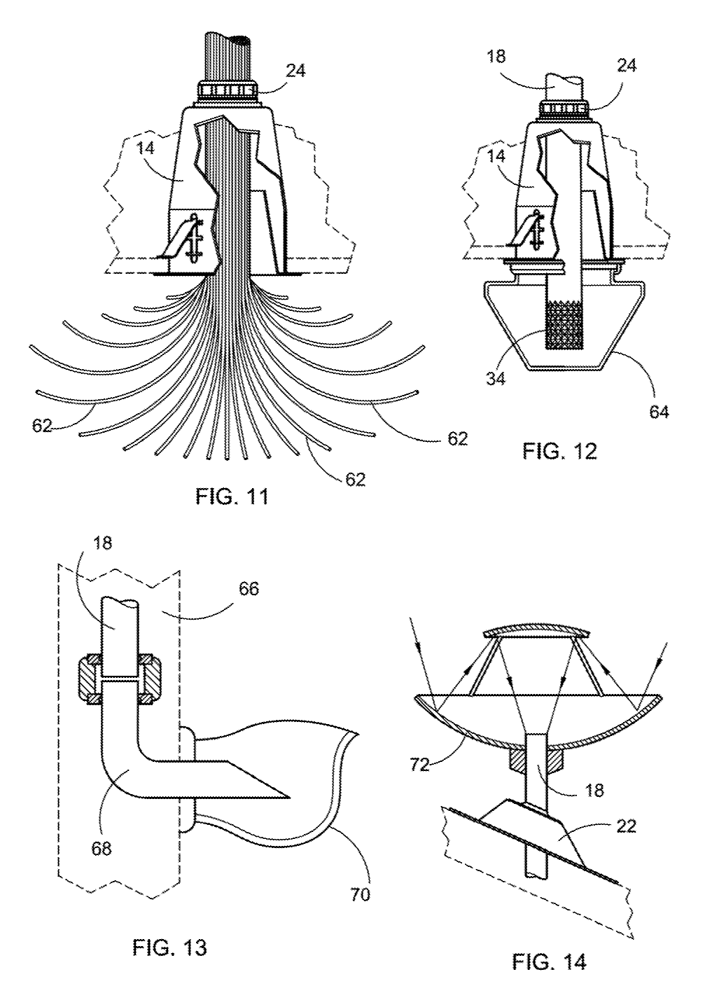

FIG. 11 depicts a cutaway side view of a ceiling light canister 14 with a quantity of small polymer rods 62 in a cluster forming a decorative display.

FIG. 12 depicts a cutaway side view of a ceiling light canister 14 with the polymer bar 18 extending further down into a larger light fixture 64.

FIG. 13 depicts a polymer bar 18 in a wall 66 and bent at a right angle 68 for use as a wall sconce 70.

FIG. 14 depicts a cross section of an optional solar reflector 72 used to increase the light entering the polymer bar 18.

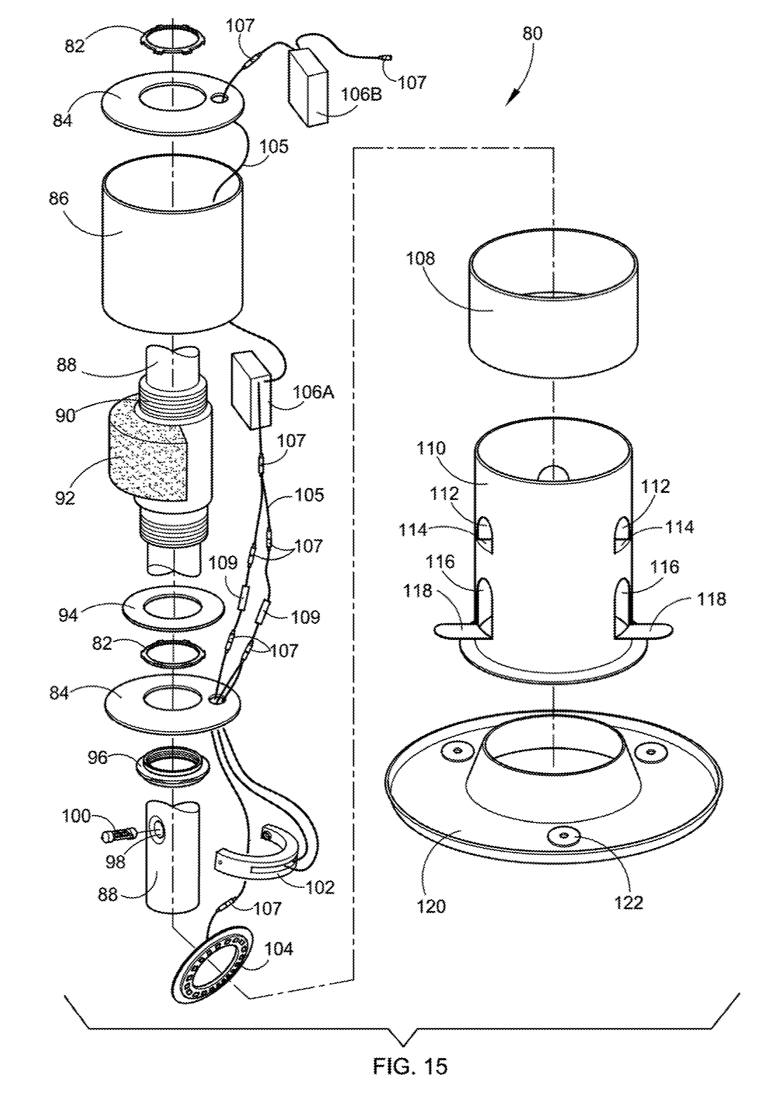

FIG. 15 depicts an exploded perspective view of a through the roof, ceiling mounting fixture 80 consisting of a lock nut 82 above the fire proofing washer 84 that will fit on top of the central core can 86. The polymer light bar 88 will pass through the central core can 86 and extend up to the roof pipe flange 22 and down through the threaded sleeve 90, having foam padding 92. The polymer light bar 88 will then pass down through a small washer 94 and lock nut 82 and fire proofing washer 84 to be secured by the means of the compression nut 96. The lower section of the polymer light bar 88 has a through orifice 98 where a LED lighting element 100 is inserted and secured by the means of an electrical connection clamp 102. An additional LED lighting ring 104 is an optional addition for further lighting enhancement. The electrical lighting components will be interconnected to a battery 106A and an optional roof mounted solar panel 46 (as shown in FIG. 6).

The electrical lighting components will be interconnected by the means of a wiring harness assembly 105 to a battery 106A and an optional roof mounted solar panel 46. A wide variety of wiring harnesses assembly 105 may be used to accommodate multiple Solar Polymer Light Bar 10 lighting units. Multi-wire connectors 107 and remote switches 109 will be incorporated into the wiring harness assembly 105. One or more batteries 106B may be incorporated within and or integrated into a through-the-roof ceiling mounting fixture 80 or housed within the next lighting unit and connected in parallel with different wiring harnesses 105. A conventional transformer may be used to replace the batteries 106A and 106B.

The assembled through the roof, ceiling mounting fixture 80 will then be inserted through the fire proofing ring 108 and into the base housing unit 110. The base housing unit 110 will have three upper openings 112 where the opening center side walls 114 will be bent in for support and three larger lower openings 116. When the unit is inserted through a hole in the drywall the opening center side walls 118 can be bent out to secure the unit in place at the final assembly within the ceiling drywall. A finish trim ring 120 will be attached from inside the room to be held in place by the means of magnetic washers 122.

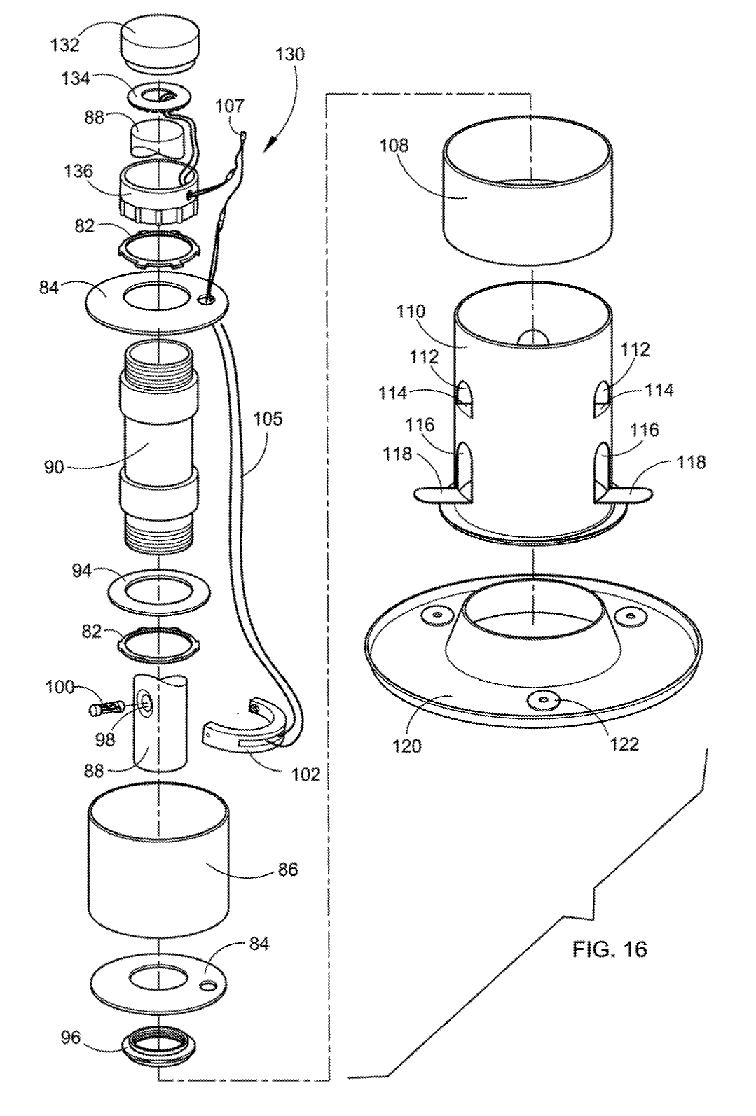

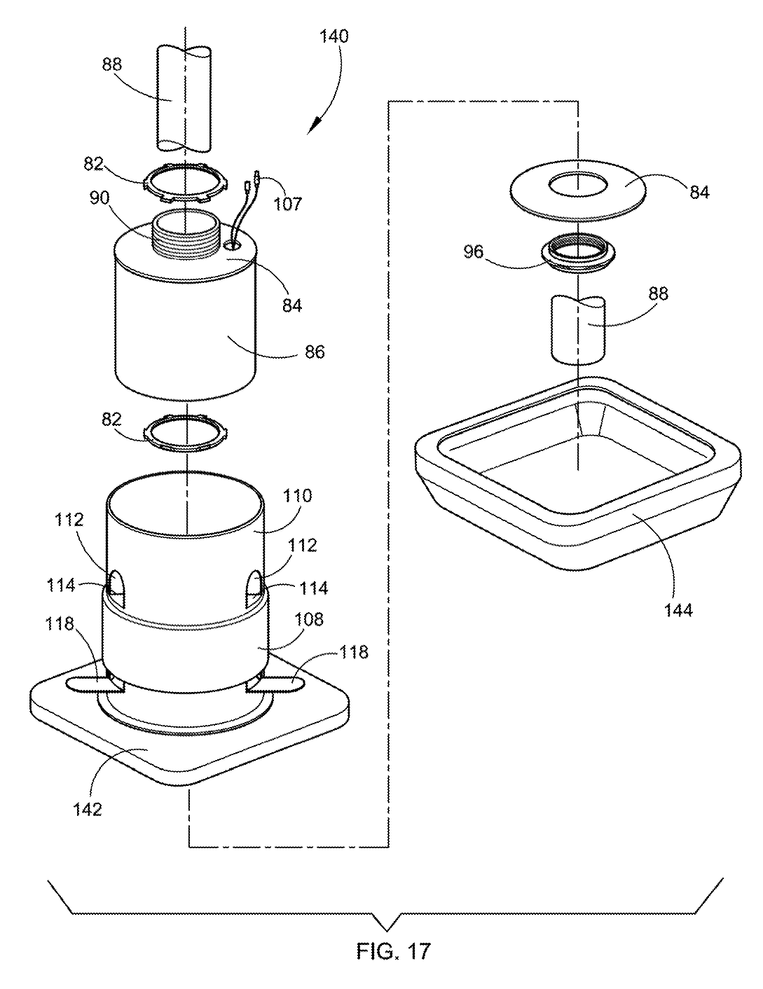

FIG. 16 depicts an exploded perspective view of an internal ceiling mounting fixture 130 consisting of a light bar cap 132 with a small LED lighting ring 134 over a polished end of the polymer light bar 88 and slipped within a threaded coupling 136. A fire proofing washer 84 is inserted on the threaded sleeve 90 with a lock washer 82 and the threaded coupling 136. At the lower end of the threaded coupling 136 is a small washer 94 and a lock not 82. The lower end of the polymer light bar 88 has a through orifice 98 where a LED lighting element 100 is inserted and secured by the means of an electrical connection clamp 102. The central core can 86 encloses the assembly then the fire proofing washer 84 is inserted with the compression nut 96. The completed assembly is inserted through the fire proofing ring 108 into the base mounting unit 110. The base housing unit 110 will have three upper openings 112 where the opening center side walls 114 will be bent in for support and there will be three larger lower openings 116. When unit is inserted through a hole in the drywall the opening center side walls 118 can be bent out to secure the unit in place at the final assembly within the ceiling drywall. A finish trim ring 120 will be attached from inside the room to be held in place by the means of magnetic washers 122.

FIG. 17 depicts an exploded perspective view of an internal ceiling dome lighting fixture 130 illustrating the light bar cap 132 with a lock nut 82. The upper end of the threaded sleeve 90 extends out of the central core can 86 with a locknut 82 below. The assembly slides into the base housing unit 110 where the center side wall 114 of the upper side wall openings 112 are folded in to support the central core cart 86 a fire proof ring 108 covers the upper portion of the lower opening 116 where the opening centers are folded out to secure the final assembly within the ceiling drywall. The mounting flange 142 for the conventional light fixture glass dome 144 is attached to the lower portion of the base housing unit 110. The fire proofing washer 8$ and the compression nut 96 will secure the upper section in place over the polymer light bar 88.

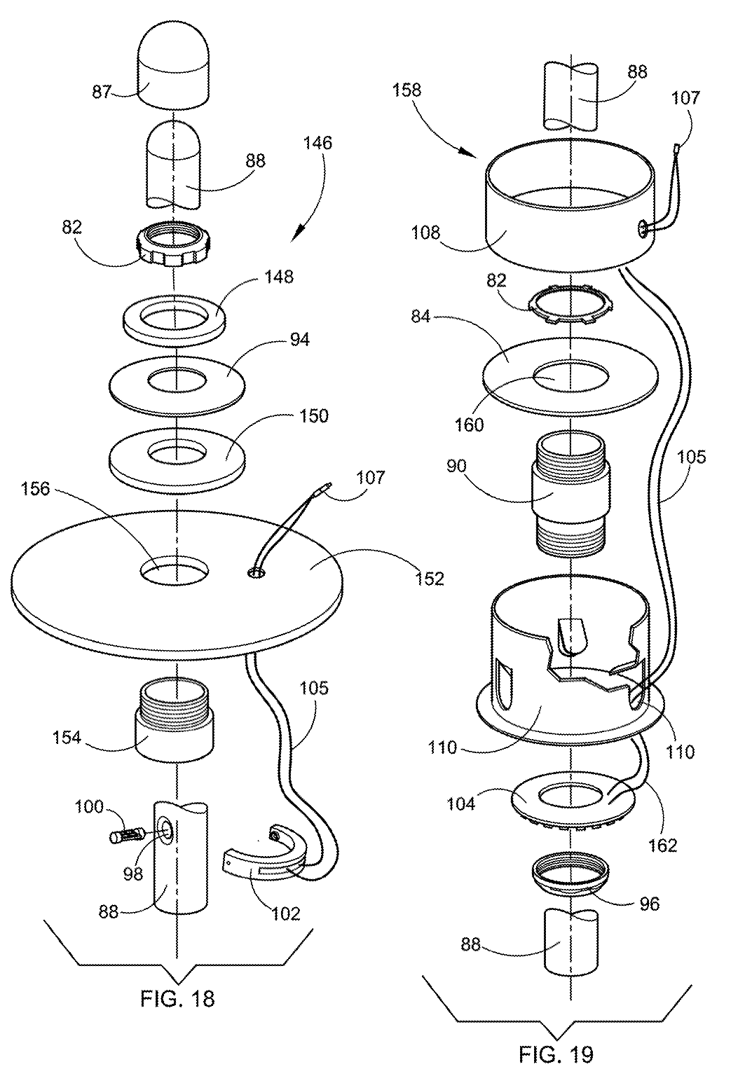

FIG. 18 depicts an exploded perspective view shed lighting fixture 146 to be installed on a single layer roof where the polymer light bar 88 extends through a lock nut 82 and a small rubber washer. A small washer 94 will sit on a larger rubber washer 150 on a roof mounting disk 152. An external threaded coupling 154 will extend through the orifice 156 in the roof mounting disk 152 to secure the unit in position. The polymer light bar 88 will extend out through the external threaded coupling 154 with an optional through orifice 98 where a LED lighting element 100 is inserted and secured by the means of an electrical connection clamp 102. An optional UV resistant protective cap 87 may be placed on the top portion of the upper polymer bar for UV damage protection.

FIG. 19 depicts an exploded perspective view of a patio lighting fixture 156 that may be used on single layer roof or a shallow layer insulated roof with the polymer light bar 88 and fire proof ring 198 above the lock nut 82 and the fire proofing washer 84 with the orifice 169 to the threaded sleeve 90. The base unit 110 has been reduced in size to accommodate shallow areas between the roof surface and room ceiling. Wiring 162 for the light ring 104 will be thread through the lower opening 116 in the base unit 110 and the compression nut 96 will secure the components together. The polymer light bar 88 is illustrated coming out the bottom.

The Solar Polymer Light Bar 10 shown in the drawings and described in detail herein disclose arrangements of elements of particular construction and configuration for illustrating preferred embodiments of structure and method of operation of the present application. It is to be understood, however, that elements of different construction and configuration and other arrangements thereof, other than those illustrated and described may be employed for providing a Solar Polymer Light Bar 10 in accordance with the spirit of this disclosure, and such changes, alternations and modifications as would occur to those skilled in the art are considered to be within the scope of this design as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A solar polymer light bar comprising:
a light transmitting polymer rod having an upper portion, a middle portion and a lower portion;
wherein said light transmitting polymer rod upper portion extends above a structure's exterior roof surface to gather sun and sky light;
wherein said light transmitting polymer rod middle portion extends through the space between the structure's exterior roof surface and the structure's interior ceiling surface; and
further wherein said light transmitting polymer rod lower portion extends downward through a structure's interior ceiling surface and into a light fixture to transmit light through said light transmitting polymer rod into said light fixture and thereby into a room in a building;
whereby said light transmitting polymer rod may be bent as required to avoid roof structural elements and ceiling structural elements when being installed.

2. The solar polymer light bar according to claim 1, wherein said light transmitting polymer rod upper portion further includes means for enhancing the inherent light gathering capacity of the polymer rod.

3. The solar polymer light bar according to claim 2, wherein said means for enhancing the inherent light gathering capacity of the polymer rod upper portion include a parabolic solar reflector.

4. The solar polymer light bar according to claim 1, wherein said polymer rod is composed of thermoplastic polymer, glass, composite materials, and polymer fibers.

5. The solar polymer light bar according to claim 1, wherein said polymer rod is assembled from one or more polymer rod sections connected together using fluid filled couplers.

6. The solar polymer light bar according to claim 1, wherein said light transmitting polymer rod lower portion further includes means for enhancing the inherent light emitting capacity of the polymer rod.

7. The solar polymer light bar according to claim 6, wherein said means for enhancing the light emitting capacity of the light transmitting polymer rod lower portion includes frosting the light transmitting polymer rod lower portion.

8. The solar polymer light bar according to claim 1, wherein a light fixture is attached to said light transmitting polymer rod lower portion.

9. The solar polymer light bar according to claim 8, wherein said light fixture attached to said light transmitting polymer rod lower portion includes an alternate LED light source.

10. The solar polymer light bar according to claim 9, wherein said alternate LED source is powered by a battery, by solar power, and by house power in the form of alternating current (AC) or direct current (DC).

11. A method for making a solar light bar, comprising the steps of:
(a) providing a light transmitting polymer rod having an upper portion, a middle portion and a lower portion;
(b) extending said light transmitting polymer rod upper portion above a structure's exterior roof surface to gather sun and sky light;
(c) extending said light transmitting polymer rod middle portion through the space between the structure's exterior roof surface and the structure's interior ceiling surface; and
(d) extending said light transmitting polymer rod lower portion downward through a structure's interior ceiling surface and into a light fixture to transmit light through said light transmitting polymer rod into said light fixture and thereby into a room in a building;
whereby said light transmitting polymer rod may be bent as required to void roof structural elements and ceiling structural elements when being installed.

12. The method for making a solar polymer light bar according to claim 11, wherein said light transmitting polymer rod upper portion further includes means for enhancing the inherent light gathering capacity of the polymer rod.

13. The method for making a solar polymer light bar according to claim 12, wherein said means for enhancing the inherent light gathering capacity of the polymer rod upper portion include a parabolic solar reflector.

14. The method for making a solar polymer light bar according to claim 11, wherein said polymer rod is composed of thermoplastic polymer, glass, composite materials, and polymer fibers.

15. The method for making a solar polymer light bar according to claim 11, wherein said polymer rod is assembled from one or more polymer rod sections connected together using fluid filled couplers.

16. The method for making a solar polymer light bar according to claim 11, wherein said light transmitting polymer rod lower portion further includes mean, for enhancing the inherent light emitting capacity of the polymer rod.

17. The method for making a solar polymer light bar according to claim 16, wherein said means for enhancing the light emitting capacity of the light transmitting polymer rod lower portion includes frosting the light transmitting polymer rod lower portion.

18. The method for making a solar polymer light bar according to claim 11, wherein a light fixture is attached to said light transmitting polymer rod lower portion.

19. The method for making a solar polymer light bar according to claim 18, wherein said light fixture attached to said light transmitting polymer rod lower portion includes an alternate LED light source.

20. The method for making a solar polymer light bar according to claim 19, wherein said alternate LED source is powered by a battery, by solar power, and by house power in the form of alternating current (AC) or direct current (DC).
